(19) United States
(12) Patent Application Publication
(10) Pub. No.: US 2006/0227101 A1
(43) Pub. Date: Oct. 12, 2006

(54) Hand-held screen-interface device

(76) Inventor: Chester T. Kackman, San Diego, CA (US)

Correspondence Address: L. Howard Chen;PRESTON GATES & ELLIS LLP, 55 Second Street, Suite 1700, San Francisco, CA, 94102-3493, US

(21) Appl. No.: 11/094,912

(22) Filed: Mar. 30, 2005

(51) Int. Cl. G09G 5/00

(52) U.S. Cl. 345/156

(57) ABSTRACT

A hand-held screen-interface device may include the following. A base has an arm brace coupled to and extending from the base. A first finger receptacle is coupled to the arm brace and positioned away from the base. A first selector switch is coupled to the first finger receptacle. A pointer device is coupled to the first finger receptacle and is configured to interface with a screen of an electronic device in communication with the hand-held screen-interface device.

### FIELD OF THE INVENTION

The present invention relates to electronic interface devices in general, and more particularly to a hand-held screen-interface device.

### BACKGROUND OF THE INVENTION

Modern electronics, including computers, personal digital assistants (PDA), cell phones, and so forth have different modes for interfacing with them, for example keyboards/pads, touch screens, microphones and voice recognition.

As an input device, a mouse is commonly found on desktops, with variations of the mouse built in to laptops. One problem with the mouse is the amount of space it takes in order to effectively operate, typically needing an area of 6″×6″. Although not a problem for desktop computers, this space may not be readily available to users of laptops, and, increasingly common, users of cell phones, PDAs, cameras, and the myriad of other devices having screen interfaces that could benefit from a pointer guided by a mouse.

Another problem with conventional mice with respect to laptops is that in order to engage them, a user must take their hand away from the keyboard. The user is unable to simultaneously keep their fingers engaged and manipulate the mouse.

Accordingly, what is needed is a hand-held screen interface device. The present invention addresses such a need.

### BRIEF SUMMARY OF THE INVENTION

The present invention provides a hand-held screen-interface device that may include the following. A base has an arm brace coupled to and extending from the base. A first finger receptacle is coupled to the arm brace and positioned away from the base. A first selector switch is coupled to the first finger receptacle. A pointer device is coupled to the first finger receptacle and is configured to interface with a screen of an electronic device in communication with the hand-held screen-interface device.

### BRIEF DESCRIPTION OF SEVERAL VIEWS OF THE DRAWINGS

FIG. 1 is a diagram illustrating a side view of one embodiment of a hand-held screen-interface device.

FIG. 2 is a diagram illustrating a side view of the device in FIG. 1.

FIG. 3 is a diagram illustrating one embodiment of a hand-held screen-interfacing device held in a user's hand.

### DETAILED DESCRIPTION OF THE INVENTION

The present invention relates to electronic interface devices in general, and more particularly to a hand-held screen-interface device. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

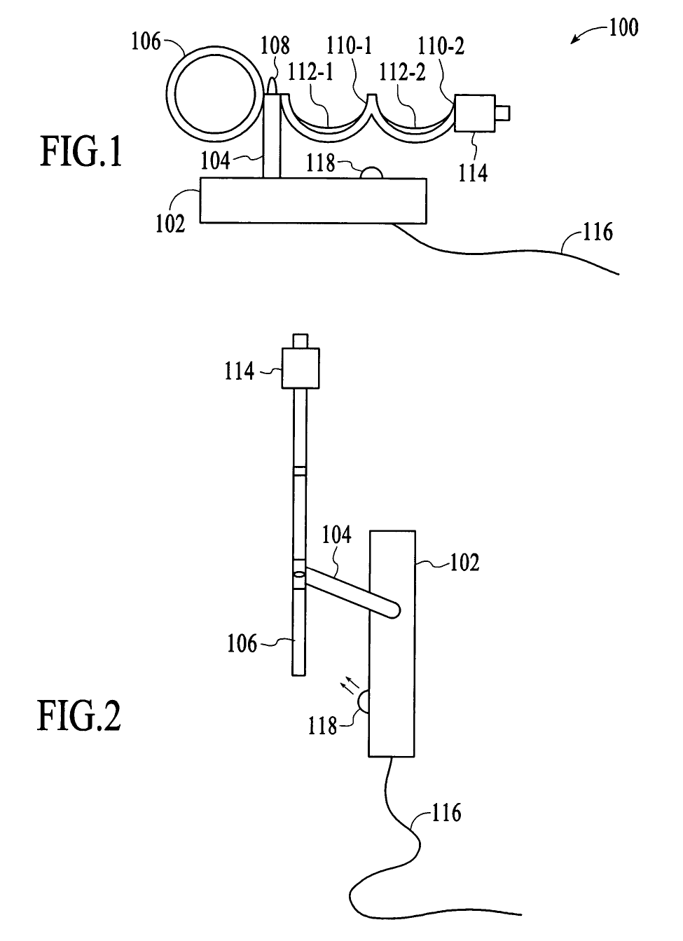

FIG. 1 is a diagram illustrating a side view of one embodiment of a hand-held screen-interface device 100. Device 100 includes base 102 that may rest against a user's palm in order to support and stabilize device 100 during use.

Arm brace 104 is attached to base 102 and extends outwardly. Arm brace 104 may be fixed to base 102 or adjustably mounted, for example with a pivot, swivel, slide, ball, hinge, cam, etc. Although the side view of base 102 is a rectangle, more ergonomic and different shapes and sizes are possible, especially to accommodate hands with different sizes and needs.

Arm brace 104 extends outwardly from base 102, perpendicular in the plane of viewing for FIG. 1, and connects to anchor 106. Anchor 106 may be sized and shaped as a ring in order to fit around the finger of a user's hand, for example the ring finger or third finger from the thumb. Anchor 106 may be sized in order to closely fit a user's finger and may be detachable in order to accommodate anchors 106 with different sizes or shapes.

Arm brace 104 may include scroll wheel 108 rotateably mounted to arm brace 104 and protruding from arm brace 104.

Finger receptacles 110-1 and 110-2 (collectively referred to as finger receptacles 110) may be rigidly attached to arm brace 104 and each other. Each finger receptacle may have the shape of a half circle, with a convex side facing base 102 and a concave side facing away from base 102. Each finger receptacle 110 may include one of selector switches 112-1 and 112-2 (collectively referred to as selector switches 112) mounted to the concave side. Finger receptacles 110 may be shaped or sized differently in order to best accommodate a user's fingers, as well as offset from one another for a more ergonomic fit (not shown).

Pointer device 114 may be attached to finger receptacle 110-2. In one embodiment pointer device 114 is a thumb force control stick. In another embodiment pointer device 114 is a ball pad, and in yet another embodiment pointer device 114 is a capacitive touch pad.

Device 100 functions as follows. A user (not shown) may insert the ring finger of either hand into anchor 106 and press base 102 against their palm, somewhat wrapping their hand about device 100 in one mode of use, and thereby providing support and stability to device 100. With device 100 secured, the user may place their middle finger in or near finger receptacle 112-1, with their index finger in or near finger receptacle 112-2. The user's thumb may be positioned on or near pointer device 114.

In order to operate, device 100 must be in communication with an electronic device having a screen with a user interface. Examples of such electronic devices are watches, cell phones, laptop computers, personal digital assistants (PDAs), MP3 players, hand-held game consoles, televisions, etc. Any interface between the electronic device and device 100 may be used, whether wired or wireless. For example, universal serial bus (USB), RS232 connection, BLUETOOTH, and infra-red (IR) are all acceptable. Optional cable 116 and optional wireless port 118 are illustrated in FIG. 1. Device 100 may be connected to any device with a compatible interface and programming. Base 102 may include the electronics necessary for routing signals from selector switches 112, scroll wheel 108, and pointer device 114 through the wired or wireless connection.

Once connected, device 100 functions in a manner similar to a conventional mouse. The user may manipulate a cursor on a screen (not shown) with pointer device 114. For example, if the user manipulates pointer device 114 with their thumb to position the cursor over an object, the object may be selected by pressing the index finger on selector switch 112-1 or the middle finger on selector switch 112-2. Either of selector switches 112 may be configured to operate as a left or right mouse button of a conventional mouse. Scroll wheel 108 may also move pages up and down or be used to browse the Internet, for example. Scroll wheel 108 may be engaged by the middle finger, for example.

In another embodiment, arm brace 104 may be positioned between finger receptacle 110-1 and 110-2, rather than between finger receptacle 110-1 and anchor 106. A ring finger may still be inserted into anchor 106, while either the middle or index fingers may rotate scroll wheel 108.

In another embodiment, device 100 may have one of finger receptacles 110, such that a user's middle (or ring) finger may be inserted into anchor 106. There may be one large finger receptacle 110 with two selector switches 112, one standard sized finger receptacle 110 with one selector switch, and so on.

FIG. 2 is a diagram illustrating a side view of device 100 in FIG. 1. In this embodiment, arm brace 104 is offset from base 102 at an angle. The positional relationship between pointer device 114, anchor 106 and finger receptacles 110 may be changed with respect to base 102 in whatever manner a user desires, for example with an adjustable arm brace. FIG. 2, for example, illustrates an offset angle different from that illustrated in FIG. 1.

One advantage of the invention is that with anchor 106, a user may relax their grip on device 100 and have their hands on the keyboard of a laptop, for example. While typing the user may quickly switch to using device 100 without having to remove their hands from the keyboard because the basic shape that the hand forms during typing is sufficient for operating device 100. Although base 102 is useful for stabilizing and supporting device 100 during use, it is not necessary. Anchor 106 is sufficient support for manipulation of device 100.

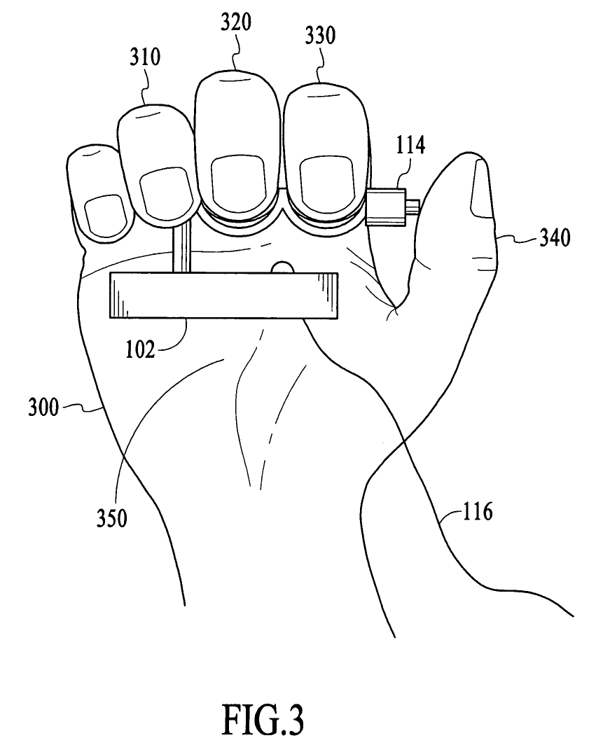

FIG. 3 is a diagram illustrating one embodiment of a hand-held screen-interfacing device 100 in use. A user's hand 300 contains device 100, with anchor 106 attached to and hidden on user's ring finger 310. User's middle finger 320 is positioned over finger receptacle 110-1 while user's index finger 330 is positioned over finger receptacle 110-2. User's thumb 340 is positioned to manipulate pointer device 114. Base 102 may rest against the user's palm 350 with user's hand 300 curled about device 100, or hand 300 may be open, or resting against an object, for example, a keyboard (not shown).

Another advantage of the invention is the ability to use the invention in tight places where a conventional mouse is impractical, or with devices traditionally lacking a mouse. For example, the invention may be plugged in or wirelessly linked to a cell phone for web browsing, or a hand-held game console, or a PDA, used for browsing the Internet on a television, and so on. The invention may replace the keys on a cell phone or camera, which are typically small and difficult to operate.

According to the method and system disclosed herein, the present invention provides a hand-held screen interface device. The present invention has been described in accordance with the embodiments shown, and one of ordinary skill in the art will readily recognize that there could be variations to the embodiments, and any variations would be within the spirit and scope of the present invention. Furthermore, the preceding Figures are not drawn to scale. Accordingly, many modifications may be made by one of ordinary skill in the art without departing from the spirit and scope of the appended claims.

We claim:

1. A hand-held screen-interface device comprising:
a base;
an arm brace coupled to and extending from the base;
a first finger receptacle coupled to the arm brace and positioned away from the base;
a first selector switch coupled to the first finger receptacle; and
a pointer device coupled to the first finger receptacle and configured to interface with a screen of an electronic device in communication with the hand-held screen-interface device.

2. The hand-held screen-interface device of claim 1 further comprising:
a second finger receptacle coupled to the arm brace; and
a second selector switch coupled to the second finger receptacle.

3. The hand-held screen-interface device of claim 2 with the arm brace coupled between the first finger receptacle and the second finger receptacle.

4. The hand-held screen-interface device of claim 3 further comprising:
an anchor having an approximately circular shape directly connected to the second finger receptacle and positioned away from the base.

5. The hand-held screen-interface device of claim 2 with the second finger receptacle coupled between the arm brace and the second finger receptacle.

6. The hand-held screen-interface device of claim 5 further comprising:
an anchor having an approximately circular shape directly connected to the arm brace and positioned away from the base.

7. The hand-held screen-interface device of claim 1, the first receptacle shaped in a half circle and having a concave side facing away from the base, the first selector switch mounted to the concave side.

8. The hand-held screen-interface device of claim 2, the first receptacle shaped in a half circle and having a concave side facing away from the base, the first selector switch mounted to the concave side, the second receptacle shaped in a half circle and having a concave side facing away from the base, the second selector switch mounted to the concave side.

9. The hand-held screen-interface device of claim 1 further comprising:
an anchor having an approximately circular shape coupled to the arm brace and positioned away from the base.

10. The hand-held screen-interface device of claim 9 with the anchor, the first finger receptacle, and the pointer device all rigidly coupled to the arm brace, the anchor providing support for manipulation of the pointer device and the first selector switch by a user.

11. The hand-held screen interface device of claim 10 with the arm brace adjustably mounted to the base, wherein the anchor, finger receptacle and the pointer device are adjustably positioned with respect to the base.

12. The hand-held screen-interface device of claim 1 further comprising:
a scroll wheel rotateably mounted to the arm brace and electrically connected to the base, and configured to manipulate the screen of the electronic device in communication with the hand-held screen-interface device.

13. The hand-held screen-interface device of claim 1 with the base having a transceiver for wireless communication with the electronic device.

14. The hand-held screen-interface device of claim 1 with the base having a transmission line for wired communication with the electronic device.

15. The hand-held screen-interface device of claim 1 with the pointer device electrically connected to the base and configured to manipulate a cursor on the screen of the electronic device in communication with the hand-held screen-interface device.

16. The hand-held screen-interface device of claim 1 with the first selector switch electrically connected to the base and configured to select screen objects on the screen of the electronic device in communication with the hand-held screen-interface device.

17. The hand-held screen-interface device of claim 1 with the arm brace adjustably coupled to the base, wherein the position of the first finger receptacle and the pointer device is variable with respect to the base.

18. The hand-held screen-interface device of claim 1 with the pointer device comprising a thumb control stick.

19. A hand-held mouse comprising:
a base;
an arm brace coupled to and extending from the base;
a finger receptacle coupled to the arm brace and positioned away from the base, the finger receptacle shaped in a half circle and having a concave side facing away from the base;
a selector switch coupled to the finger receptacle and mounted to the concave side;
an anchor having an approximately circular shape coupled to the finger receptacle and positioned away from the base;
a pointer device coupled to the finger receptacle and configured to interface with a screen of an electronic device in communication with the hand-held mouse, wherein the anchor, the first finger receptacle, and the pointer device are rigidly coupled to the arm brace, the anchor providing support for manipulation of the pointer device and the first selector switch by a user; and
a scroll wheel rotateably mounted to the arm brace and electrically connected to the base and configured to manipulate the screen.

20. A hand-held screen-interface device comprising:
an anchor having an approximately circular shape;
a first finger receptacle coupled to the anchor;
a first selector switch coupled to the first finger receptacle; and
a pointer device coupled to the first finger receptacle and configured to interface with a screen of an electronic device in communication with the hand-held screen-interface device.

21. The hand-held screen-interface device of claim 20 further comprising:
a second finger receptacle coupled to the first finger receptacle; and
a second selector switch coupled to the second finger receptacle.

22. The hand-held screen-interface device of claim 20, the first receptacle shaped in a half circle and having a concave side, the first selector switch mounted to the concave side.

23. The hand-held screen-interface device of claim 21, the first receptacle shaped in a half circle and having a concave side, the first selector switch mounted to the concave side, the second receptacle shaped in a half circle and having a concave side, the second selector switch mounted to the concave side.

24. The hand-held screen-interface device of claim 20 with the anchor, the first finger receptacle, and the pointer device all rigidly coupled together, the anchor providing support for manipulation of the pointer device and the first selector switch by a user.

25. The hand-held screen-interface device of claim 20 further comprising:
a scroll wheel rotateably mounted to the second finger receptacle, and configured to manipulate the screen of the electronic device in communication with the hand-held screen-interface device.

26. The hand-held screen-interface device of claim 20 further comprising:
a transceiver coupled to the anchor for wireless communication with the electronic device.

27. The hand-held screen-interface device of claim 20 further comprising:
a transmission line coupled to the anchor for wired communication with the electronic device.

28. The hand-held screen-interface device of claim 20 with the pointer device comprising a thumb control stick.
